(19) United States
(12) Patent Application Publication
(10) Pub. No.: US 2015/0015588 A1
(43) Pub. Date: Jan. 15, 2015

(54) AUTOMATIC HARDWARE ACCELERATED RENDERING TO SOFTWARE RENDERING FALLBACK

(71) Applicant: Google Inc., Mountain View, CA (US)

(72) Inventor: Romain P. Guy, Millbrae, CA (US)

(21) Appl. No.: 13/735,598

(22) Filed: Jan. 7, 2013

Related U.S. Application Data
(60) Provisional application No. 61/583,510, filed on Jan. 5, 2012.

(51) Int. Cl. G09G 5/00

(52) U.S. Cl. CPC G09G 5/003
USPC 345/501

(57) ABSTRACT

Methods, systems, and apparatus, including computer programs encoded on a computer storage medium, for software fallback upon detecting an error in hardware accelerated rendering. A display of an application is rendered using hardware acceleration. In response to detecting an error in the hardware accelerated rendering of the display, hardware acceleration is disabled for further rendering of the display. Subsequent to disabling the hardware acceleration for further rendering of the display, the display is rendered without hardware acceleration.

### CROSS-REFERENCE TO RELATED APPLICATION

This application claims priority to U.S. Provisional Application Ser. No. 61/583,510, filed on Jan. 5, 2012, the entire contents of which are hereby incorporated by reference.

### TECHNICAL FIELD

This document relates to components of computer operating systems, including components for graphical rendering.

### BACKGROUND

Computer operating systems perform a number of functions, including serving as a bridge between computer hardware and computer applications that run on the operating systems. Modern computer operating systems also provide basic graphical user interfaces (GUIs) by which users can interact with components of the operating system in more intuitive manners.

In some computing systems, the resources available for rendering graphics may include hardware acceleration, which when utilized may increase system performance and allow for superior graphics rendering by providing dedicated hardware, such as a graphics processing unit (GPU), to more quickly process code requiring significant computational resources. A system may therefore provide access to hardware acceleration for many applications.

However, third party applications, particularly multi-platform applications, may not be fully compatible with hardware acceleration on a specific device. Typically when the hardware encounters an error in rendering an application, the application crashes, which causes consternation for a user. This can discourage the user from using the application, and can discourage application developers from taking advantage of the hardware acceleration feature.

### SUMMARY

This document describes systems and techniques that may be used for managing objects within a graphical user interface for a computer operating system. As described in examples in this document, an error in hardware rendering may be identified, such as by the rendering hardware itself. The rendering hardware may then shut itself down and take actions to force the corresponding application to attempt to perform the rendering again. Upon attempting the rendering again, the system may notice that the hardware rendering is unavailable, and may perform the rendering using software. As a result, crashes may be avoided, while hardware acceleration can be maintained under normal operating conditions so as to provide improved experiences for users of a computing device or broader computing system.

As one such implementation, a computer-implemented method includes rendering a display of an application using hardware acceleration; detecting an error in the hardware accelerated rendering of the display; in response to detecting the error, disabling hardware acceleration for further rendering of the display; and subsequent to disabling the hardware acceleration for further rendering of the display, rendering the display without hardware acceleration.

In some implementations, the method may further include detecting that hardware acceleration has been disabled for rendering the display, wherein rendering the display without hardware acceleration is based on detecting that the hardware acceleration has been disabled.

In some implementations, the method may further include generating a hardware renderer, the hardware renderer performing the step of rendering the display using hardware acceleration, wherein disabling hardware acceleration comprises destroying the hardware renderer. Rendering the display without hardware acceleration may be based on detecting the absence of a hardware renderer for the display. The error may be an impermissible state.

In another embodiment, a computer-implemented method may include identifying a hardware renderer associated with an application; interfacing with the hardware renderer in order to render a display screen associated with the application using hardware acceleration; subsequent to rendering the display screen using hardware acceleration, identifying the absence of a hardware renderer associated with the application; and interfacing with a different renderer associated with the application in order to render another display screen associated with the application without using hardware acceleration.

In some implementations, the method may further include destroying the hardware renderer based on detecting a rendering error.

The details of one or more implementations are set forth in the accompanying drawings and the description below. Other features and advantages will be apparent from the description and drawings, and from the claims.

### BRIEF DESCRIPTION OF THE DRAWINGS

FIG. 1 shows a diagram of a visual element hierarchy with hardware acceleration settings.

FIG. 2 is a flowchart of an example method for determining hardware accelerated rendering settings.

FIGS. 3A-B are flowcharts of example processes for rendering a graphical object.

FIG. 4 shows aspects of an example device for displaying content, which may be used with the techniques described here.

FIG. 5 shows an example of a generic computer device and a generic mobile computer device, which may be used with the techniques described here.

### DETAILED DESCRIPTION

This document describes mechanisms by which an operating system may manage interactions with graphical objects that can be viewed by and/or manipulated by a user of a computing device. The operating system may provide access to hardware resources to certain graphical processes in order to provide graphics acceleration for those processes. The hardware resources may be allocated to different graphical processes in order to process graphical elements from different sources, and may manage the interaction between concurrently running graphical processes.

When one of these processes encounters an error in hardware rendering, rather than ending the process, the process falls back to software rendering and continues to run. The process continues to run without the use of hardware resources until the next time the process is initialized. Disabling hardware acceleration for the process using the fallback does not adversely affect other processes also using the hardware resources; other graphics processes may continue to use hardware accelerated rendering while the problem process falls back to software rendering.

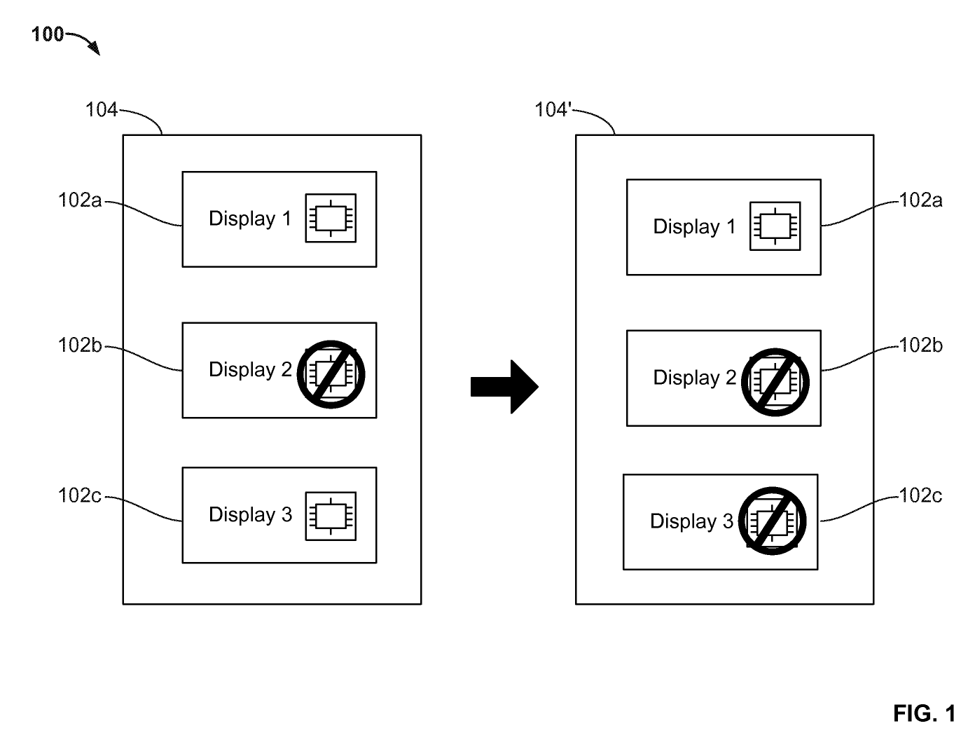

FIG. 1 illustrates a computing system 100 in which three different processes have displays 102a, 102b, 102c which are rendered, processed, and displayed by the computer system as it transitions from a state 104 to another state 104′. Depending on the multi-tasking and process scheduling capabilities of the computer system 100, one or more of these displays may be associated with a process that is running in the background, in a suspended state, or otherwise subordinated to one or more of the other processes running actively when the system 100 is in state 104. Each of the process may be in queue as part of the system's process scheduling, and one or more of the processes may be a system process that is designed primarily or only to run in the background. Other processes may be applications or widgets within the system such that they can have focus in their display. Most notably, each of the displays 102a, 102b, 102c is managed by a graphics system in order to render, process, and display graphical objects associated with the display 102a, 102b, 102c.

When the computing system 100 is in the state 104, the display 102a takes advantage of hardware acceleration by using a hardware renderer. The hardware-enabled setting for the display 102a is represented in FIG. 1 by a chip icon. The display 102a is therefore rendered using hardware resources for at least some portions the necessary computation.

The display 102b uses software rendering, represented by the chip icon being negated (no hardware acceleration). Dedicated hardware resources are not allocated to this process; the graphics system uses a general-purpose processor (CPU) of the computing system 100 and the appropriate software resources in order to render the display 102b. The process associated with the display 102b may generate and use a software renderer in order to aid in rendering the display 102b.

The display 102c initially uses hardware acceleration when the computing system 100 is in a first state 104. This hardware-enabled setting is again shown by a chip icon in FIG. 1. It some implementations, the display 102c may be allocated hardware resources from the same hardware available for rendering the display 102a. The process associated with the display 102c may therefore also generate and use a hardware renderer in order to interface with a graphics system. The process may use both a dedicated component for hardware acceleration such as a GPU and resources associated with the more generic components such as the CPU for the computing system 100.

The transition between the first state 104 and second state 104′ for the settings of the computing system 100 occurs upon detection of an error in the execution of the hardware renderer associated with the display 102c. The triggering event may be a signaled error or invalid state. The error may be thrown by any component of the graphics system associated with hardware rendering, including the underlying graphics API.

Upon detection of the rendering error, the system falls back to software rendering for the display 102c, as shown by the negation of the chip icon, representing a hardware-disabled setting for the display 102c in the second state 104′.

Typically, a rendering error would crash the process attempting to render the display, and may further cause difficulties with other processes managed by the same graphics system. The fallback as herein described allows the process to continue without crashing, giving it another opportunity to render the display 102c, albeit without the benefits of the hardware resource.

As shown in the state 104′ of the computing system 100, although the display 102c has fallen back to software-rendering, the display 102a still shows a hardware-enabled setting. The fallback as herein described may further allow other processes to continue to use hardware accelerated rendering despite the fallback with respect to the problem process.

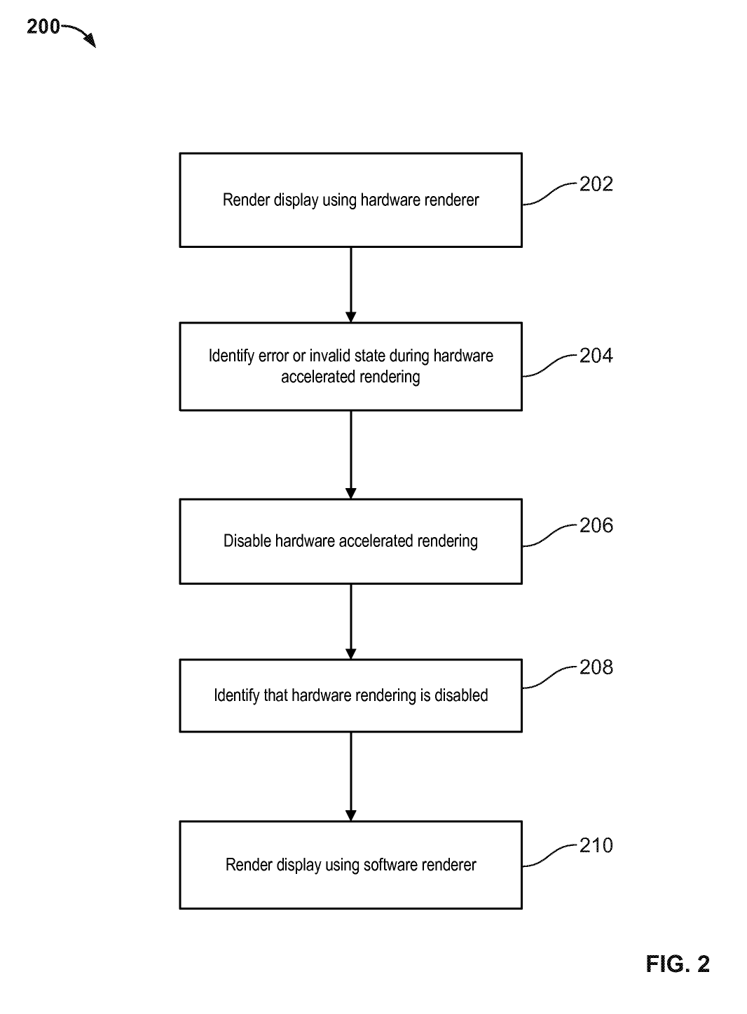

FIG. 2 illustrates a software renderer fallback process by means of a flowchart 200. Although shown in a certain order, it will be understood that certain steps in the described process may occur in a different order or concurrently, that certain steps may occur repeatedly or within different components or processes within a computing system, and that not all of the described steps will be found in every implementation.

In this example process, a hardware renderer is used to accelerate the rendering of a display using an available hardware resource (202). The hardware renderer may be an object generated and paired for the specific display or the process or application associated with the display, or the renderer may be a component of the underlying graphics process that is responsible for managing the hardware resource with respect to multiple display contexts. The hardware renderer may be a rendering engine compatible with the graphics system controlling the hardware resource.

The hardware resource may be any component of a computing system for which resources can be made especially available for use in rendering graphics associated with the display. The graphics system may manage the hardware resources and may apportion resources out to multiple processes according to available priority rules; the availability of the hardware resource may affect whether a given display is hardware accelerated when hardware acceleration is requested. In some implementations, the hardware resource may be a dedicated processing unit such as a GPU, which may include a processor and memory separate from the CPU used by the rest of the computing system. The decision to generate and pair a hardware renderer may be made by an operating system in conjunction with signals from the application or display and analysis of the available resources.

In one embodiment, the underlying graphics system may be a graphics API such as OpenGL. Because this process is addresses compatibility and rendering errors, it will be understood that both new and existing graphics systems, particularly graphics systems designed to be available to newly developed applications and third-party development, can benefit from the fallback capabilities described herein.

The hardware accelerated renderer is paired to the display, often associated with a specific application or even a specific window or screen within an application. A given process may include a variety of graphical elements, and a hardware renderer may be associated with elements at different levels of a display hierarchy. In one embodiment, an application may include multiple activities. An activity may include multiple windows. A window may include multiple views. A hardware renderer may therefore be generated and paired for any of these components; for instance, a particular view may have a hardware renderer that manages the rendering of graphical objects associated with only that particular view. In another implementation, a hardware renderer may be paired to an activity, and all windows within that activity may be managed by the hardware renderer. Therefore, it should be understood that the term “display” is used with respect to whatever level or levels of the graphics component hierarchy is processed for decisions regarding hardware rendering.

The hardware renderer is used to render the application's display (202). At some point, the underlying graphics system (such as OpenGL) returns an error or invalid state (204). Any error which signals incompatibility between the instant application or process and the hardware accelerated renderer, or which simply signals a failure of the hardware renderer to properly render a display, may act as this signal.

Although an explicitly signaled error or invalid state by the underlying graphics system may be the trigger in some implementations, any detected error in the rendering may be identified in this step. Performance issues, artifacts, and other problems may also trigger a desire to disable hardware rendering. In some implementations, elements of the system may have the ability to detect common problems, exceptions, or states that are not handled correctly or optimally by the hardware renderer, and to signal that hardware accelerated rendering be disabled when these events are detected. In other implementations, only errors and invalid states reported by the underlying graphics system (for existence, rendering errors built into the API) acts as the signal for this process.

In response to detecting this error or invalid state (or, in some implementations, other events of interest), the hardware renderer destroys access to the hardware resource and disables itself (206). Where the hardware renderer is generated and dedicated to the display or process for which hardware accelerated rendering is now to be disabled, the hardware renderer object may be destroyed. Alternatively a signal or setting may be changed to remove access to the renderer for drawing the display that produced the error. Other steps involving the use of hardware resources in conjunction with a hardware renderer, for instance freeing up locked or otherwise dedicated resources held by the hardware renderer for use in rendering the display, may also be employed when destroying the renderer or access to the renderer.

In some implementations, not all errors immediately result in disabling the hardware accelerated rendering. Multiple attempts to render a display using hardware accelerated rendering may be attempted before this step is taken. The nature of the error may determine whether additional attempts will occur. Multiple errors, or errors of a certain type, may cause a fallback to software rendering; in other cases, a signal to the graphics system may first result in additional attempts to render the display before the fallback occurs. The system may be able to identify and classify fatal versus non-fatal errors and behave accordingly.

The existence of a fallback option in the event of certain thrown errors or exceptions should not be read to imply that all detected drawing errors immediately lead to the elimination of hardware acceleration from a given display or application. The level of redundancy may depend on the availability of resources, the amount of time that further investments in hardware acceleration might take, and the expected affect that disabling of hardware rendering may have on the problem display. For example, where hardware resources are already heavily used by other processes, the threshold for falling back to software rendering might be lower. An application or process with a known history of hardware rendering compatibility errors may be moved to software rendering with fewer remedial attempts than a trusted process. An application that is known to behave adequately without hardware accelerated rendering may be allowed to fall back more quickly than an application that is known to lag predictably without access to hardware acceleration resources. A display for which additional attempts at hardware acceleration are computationally inexpensive may be allowed more attempts than a display that will require heavy investment in resources for each additional attempt at hardware accelerated rendering.

Upon failure of the display to render, the graphics system attempts to render the display again, detecting that the hardware accelerated renderer is disabled (208). Again, depending on the precise configuration of the system, this can involve the renderer itself becoming absent or being destroyed, or may represent a variable read by the graphics system that indicates hardware rendering is not available. In any event, the graphics system recognizes the hardware accelerated rendering is not an option.

Having disabled or destroyed the hardware renderer, the graphics system therefore interfaces with a software renderer to render the display (210). This may involve the generation of a new software renderer object, or may involve the use of an existing engine rendering graphics using the standard general system resources.

The scope of the change may depend on the nature of the error; that is, if the rendering error likely impacted an entire application, the whole application may fall back. Alternatively, if a context specific to a certain window or view is lost or otherwise results in an error, the scope of the change may be limited to that specific window or view. In addition to the scope of the error, it may also depend on the scope of the hardware renderer; that is, the granularity of the fallback may depend in part on the granularity of the system in identifying and handling graphical components together or separately. However, as described above, it may be possible to disable the hardware renderer with respect to one or more graphical components while the hardware renderer is still able to manage hardware acceleration for other graphical components, even within the same process.

The transition between hardware accelerated rendering and software rendering may, in some implementations, be seamless and largely invisible to the user. If the system successfully renders the display following the fallback, the user may be able to continue to use the process as if no change has occurred.

However, in some implementations, it may be desirable to signal the fallback to the user. This could be done using a visible error message, which may pop up or appear on the user's screen in a location, design, and size calculated to attract attention without disrupting the display and without requiring user acknowledgement or interaction. The error message may also represent a visible display object that when interacted with (such as touching on a touch screen or clicking with a cursor) provides more information about the fallback such as current hardware acceleration settings. The user may also be able to interact with the computing system to change the display settings based on the fallback event.

Even if no deliberate signal is conveyed to the user, the user may notice a reduction is system performance when hardware acceleration is disabled. Without the benefit of hardware accelerated rendering, graphics may be slower, jerkier, or less refined, and certain applications may experience more significant load times and lag. As the device CPU may have to take on burdens usually allocated to the CPU, the entire system may visibly suffer from the loss of hardware acceleration for one system component.

In some implementations, the fallback may be recorded in an internal system log, which may be used to make further decisions about using hardware acceleration with a given display or process, and may inform later decisions on how much remedial rendering to allow before falling back following future hardware rendering errors.

The fallback may be reported to a developer associated with the software or hardware of the system. This reporting may be optional, and may occur according to a user's prior settings or in response to user interaction following the fallback event. Developers may use fallback data to identify bugs and improve compatibility between processes and hardware rendering.

Once a particular hardware resource is disabled, that particular display may be rendered using only a software renderer throughout the execution of the application—that is, until the application is reinitialized. Each execution of the application may include a fresh attempt to utilize hardware acceleration in the rendering of each display screen.

Furthermore, once a display is rendered without software acceleration, further rendering errors may still eventually result in a process crashing and needing to be re-initialized. In some embodiments, if further attempts to render a display through software rendering fail after a fallback, the system may record the event differently, as hardware acceleration may not be the cause of the problem.

In one embodiment, different display contexts may each avail themselves of hardware rendering independently, and disabling hardware rendering for one display may not affect the availability of hardware rendering for other displays. Additionally, where multiple processes are using the same graphics system (such as, for example, OpenGL) with access to hardware rendering resources, a hardware rendering error in one process should not negatively impact hardware rendering with respect to any other process. For example, where the underlying operating system user interface uses OpenGL in addition to applications executed on the device, the UI can continue to use hardware rendering even if one or more applications experience an error or invalid state in hardware rendering.

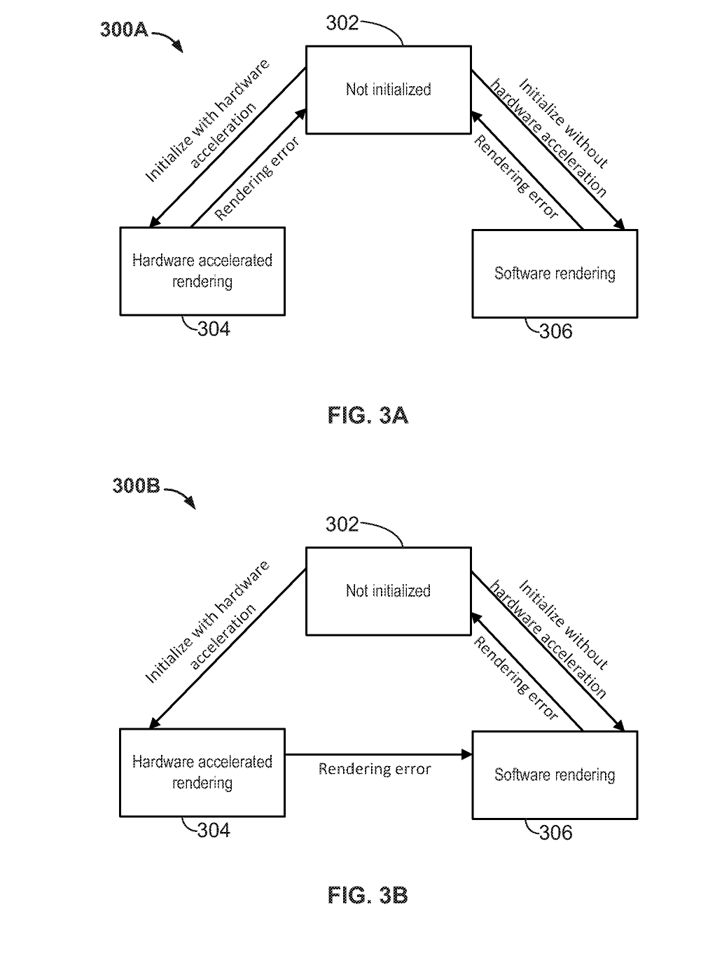

FIGS. 3A and 3B show state diagrams 300a, 300b illustrating the use of software rendering fallback by comparing a diagram for a process without fallback to a diagram for a process including fallback. The state diagram includes only events directly relevant to the processes under consideration, and it should be understood that additional events capable of moving a program between states are not shown. For example, intentionally closing or ending a process may also return a process to the “not initialized” state without crashing.

Furthermore, while the discussion with respect to FIGS. 3A and 3B is based on the state of a process, as above it should be understood that it may refer to any given display, understood to be any appropriate component of an application or process as dealt with by the graphics system. The initialization of a display context as described may occur at the initialization of a process or at a later time, and the crashing or closing of a display may or may not crash or close a larger component of the process or the entire process.

A first state diagram 300a is shown without software fallback. By default, a certain display context may be uninitialized (302). Depending on the nature of the display, it may be considered to be uninitialized whenever it is not selected as part of a larger component, whenever it is minimized, or if it is suspended as focus is given to another display or process. The display may also be uninitialized only when the relevant program or other process is not running.

Upon initialization, the display context may be initialized with hardware acceleration, and therefore use hardware rendering (304), or may be initialized without hardware acceleration, and therefore use software rendering (306). This decision may be made automatically by the graphics system or may be a user-controlled selection. The decision to pair the display to a hardware renderer may be made based on a number of factors including hardware resource availability, program and display stability, and developer preference.

In the state diagram 300a, whether the display uses hardware accelerated rendering (304) or software rendering (306), an error or invalid state crashes the display, and possibly the whole program, returning the display context to the uninitialized state (302). In some cases, the crash may even affect other processes using the same resources, or even result in a freeze or crash of the whole system.

Not all rendering errors necessarily result in a crash. Some may still allow recovery of the display context in a subsequent remedial attempt to draw the graphical objects associated with the display. However, should the rendering error or invalid state not be quickly and automatically fixed, eliminating the display by crashing the process is typically the next and only remaining option.

In contrast, an improved state diagram 300b shown in FIG. 3B includes fallback capability not available in the state diagram 300a of FIG. 3A above. Again, a display context may begin in an uninitialized state (302). Initialization with hardware acceleration still results in hardware accelerated rendering.

The change is in the response of the system to what would otherwise be a fatal hardware rendering error. Under the improved state diagram 300b which includes an embodiment of the fallback process, an error or invalid state during hardware rendering does not necessarily crash the display and perhaps the controlling process. Instead, it invokes software rendering as a fallback, destroying access to any hardware rendering resources and transferring the display to be handled by generalized software resources instead.

Subsequent rendering errors may still result in a crash and a return to an initialized display (302), as described above with respect to the unimproved process shown in FIG. 3A. However, under the improved process shown in FIG. 3B, as long as the software renderer is able to draw the display without further errors, the application does not crash due to the hardware rendering errors.

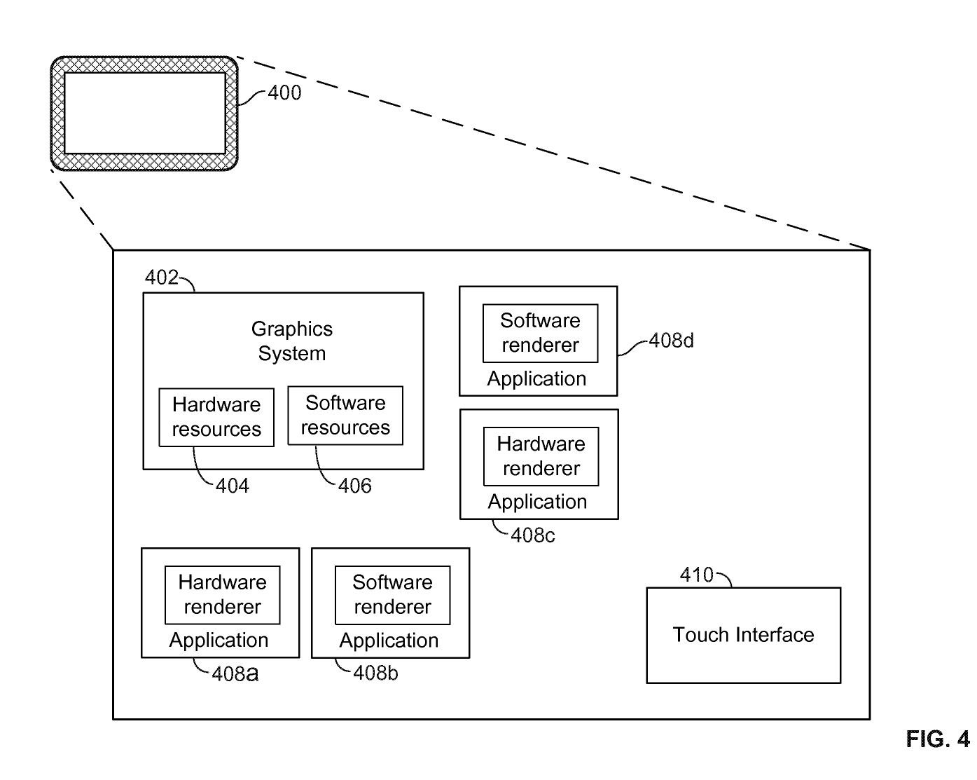

FIG. 4 shows a tablet computing device 400 as one example of a computing system within which the described software fallback processes may take place. The device 400 may be any computing device that includes at least one dedicated hardware resource available for processing graphics (such as a GPU) in addition to the generalized resources used for other computer processes (such as a CPU). Although the device 400 is shown and described as a tablet computer having a touch interface, any appropriate computing system having hardware accelerated rendering may benefit from implementations disclosed herein.

A graphics system 402, responsible for managing the resources and environment underlying all display on the device 400, includes both hardware resources 404 and software resources 406 for rendering displays associated with applications 408a-d. The graphics system may be a known API such as OpenGL, or a custom or proprietary system capable of managing the resources of the device 400. The hardware resources 404 may include a graphics processing unit (GPU) or other resources that can be dedicated to improving graphics rendering by their management and allocation. The software resources may include management processes for allocating and using generalized resources (such as the CPU, system RAM, etc) for drawing, rendering, processing, and displaying graphics on the system.

Each application 408a-d may include one or more graphics renderers, represented as renderers 410a-d. As discussed above, renderers may be generated for and paired to smaller system components than full applications, and so applications may in fact have more than one renderer associated with different graphical elements. Alternatively, a single renderer object may manage multiple elements within each application. Thus, although each of the applications 408a-d is shown having only one renderer, either hardware or software, in practice one or several of each type may be employed.

Applications 408a and 408c are using hardware renderers 410a and 410c in order to take advantage of hardware accelerated rendering. As the hardware renderers 410a and 410c interface with the graphics system 402, hardware resources 404 are made available for rendering displays associated with the applications 408a and 408c. In some cases, hardware resources 404 may even be reserved for the use of a certain renderer 410a or 410c, and released only when the renderer is destroyed due to crash, fallback, or application completion.

Applications 408b and 408d are using software renderers 410b and 410d and are not using hardware accelerated rendering.

The applications 408a-d may also interact with other system components, such as a touch interface 410, which may interact with a display in that the images rendered by the display may be matched to interactions recorded by the touch interface to determine what elements of a given application a user is interacting with.

If an error occurs in hardware rendering, a hardware renderer may be destroyed or disabled and a software renderer used instead, as described above. For example, an application 408a may generate a software renderer in response to a fallback event in which the hardware renderer 408a is disabled or destroyed.

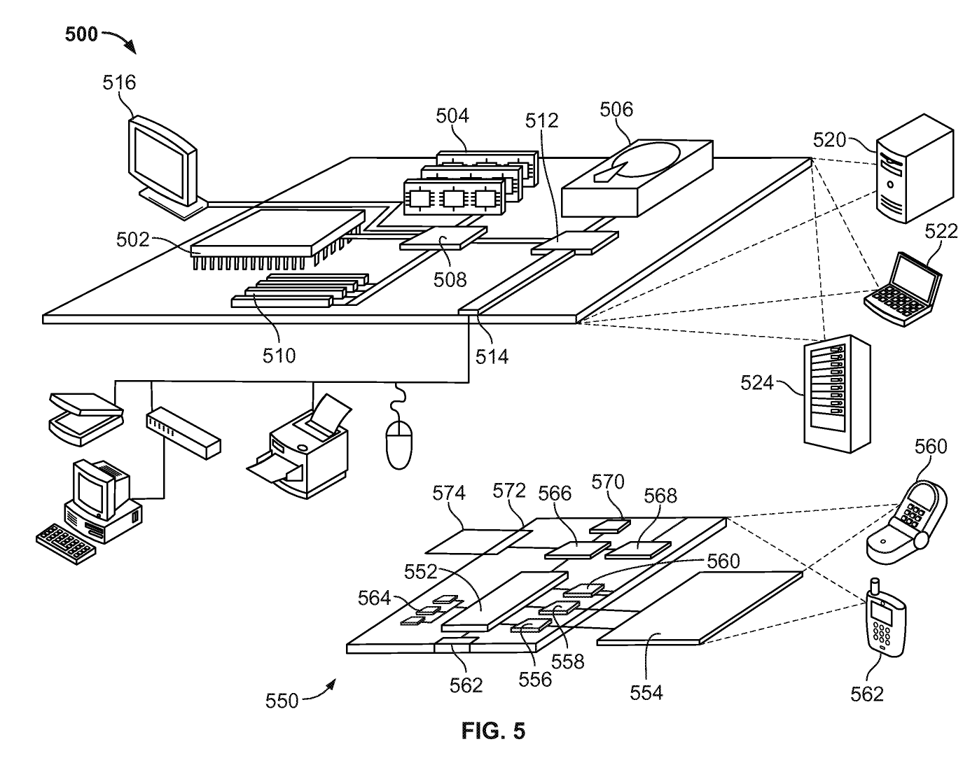

FIG. 5 shows an example of a generic computer device 500 and a generic mobile computer device 550, which may be used with the techniques described here.

Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smartphones, tablet computers and other similar computing devices. The components shown here, their connections and relationships, and their functions, are meant to be exemplary only, and are not meant to limit implementations of the techniques described and/or claimed in this document.

Computing device 500 includes a processor 502, memory 504, a storage device 506, a high-speed interface 508 connecting to memory 504 and high-speed expansion ports 510, and a low speed interface 512 connecting to low speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a volatile memory unit or units. In another implementation, the memory 504 is a non-volatile memory unit or units. The memory 504 may also be another form of computer-readable medium, such as a magnetic or optical disk.

The storage device 506 is capable of providing mass storage for the computing device 500. In one implementation, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 504, the storage device 506, memory on processor 502, or a propagated signal.

The high speed controller 508 manages bandwidth-intensive operations for the computing device 500, while the low speed controller 512 manages lower bandwidth-intensive operations. Such allocation of functions is exemplary only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can execute instructions within the computing device 550, including instructions stored in the memory 564. The processor may be implemented as a chipset of chips that include separate and multiple analog and digital processors. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT LCD (Thin-Film-Transistor Liquid Crystal Display) or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provide in communication with processor 552, so as to enable near area communication of device 550 with other devices. External interface 562 may provide, for example, for wired communication in some implementations, or for wireless communication in other implementations, and multiple interfaces may also be used.

The memory 564 stores information within the computing device 550. The memory 564 can be implemented as one or more of a computer-readable medium or media, a volatile memory unit or units, or a non-volatile memory unit or units. Expansion memory 574 may also be provided and connected to device 550 through expansion interface 572, which may include, for example, a SIMM (Single In Line Memory Module) card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provide as a security module for device 550, and may be programmed with instructions that permit secure use of device 550. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, memory on processor 552, or a propagated signal that may be received, for example, over transceiver 568 or external interface 562.

Device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth, WiFi, or other such transceiver (not shown). In addition, GPS (Global Positioning System) receiver module 570 may provide additional navigation- and location-related wireless data to device 550, which may be used as appropriate by applications running on device 550.

Device 550 may also communicate audibly using audio codec 560, which may receive spoken information from a user and convert it to usable digital information. Audio codec 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550.

The computing device 550 may be implemented in a number of different forms, as shown in the figure. For example, it may be implemented as a cellular telephone 580. It may also be implemented as part of a smartphone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A computer-implemented method comprising:
rendering a display of an application using computer hardware acceleration;
detecting an error in the computer hardware accelerated rendering of the display;
in response to detecting the error, disabling hardware acceleration for further rendering of the display; and
subsequent to disabling the hardware acceleration for further rendering of the display, rendering the display without computer hardware acceleration.

2. The method of claim 1, further comprising:
detecting that hardware computer acceleration has been disabled for rendering the display;
wherein rendering the display without hardware acceleration is based on detecting that the computer hardware acceleration has been disabled.

3. The method of claim 1, wherein detecting that the hardware acceleration has been disabled comprises re-attempting rendering with computer hardware acceleration and identifying that computer hardware acceleration is not available.

4. The method of claim 1, further comprising:
generating a hardware renderer, the hardware renderer performing the step of rendering the display using hardware acceleration;
wherein disabling hardware acceleration comprises destroying the hardware renderer.

5. The method of claim 4, further comprising:
detecting the absence of a hardware renderer for the display;
wherein rendering the display without hardware acceleration is based on detecting the absence of a hardware renderer for the display.

6. The method of claim 1, wherein the error is an impermissible state.

7. The method of claim 1, wherein rendering the display of the application comprises rendering less than all of the display of the application.

8. A computer-implemented method, comprising:
identifying a hardware renderer associated with a computer application;
interfacing with the hardware renderer to render a display screen associated with the application using hardware acceleration;
subsequent to rendering the a display screen using hardware acceleration, identifying the absence of a hardware renderer associated with the application; and
interfacing with a different renderer associated with the application in order to render another display screen associated with the application without using hardware acceleration.

9. The method of claim 1, further comprising:
detecting a rendering error;
after the hardware renderer is identified, destroying the hardware renderer based on detecting the rendering error.

10. A system comprising:
one or more computers and one or more storage devices storing instructions that are operable, when executed by the one or more computers, to cause the one or more computers to perform operations comprising:
rendering a display of an application using hardware acceleration;
detecting an error in the hardware accelerated rendering of the display;
in response to detecting the error, disabling hardware acceleration for further rendering of the display; and
subsequent to disabling the hardware acceleration for further rendering of the display, rendering the display without hardware acceleration.

11. The system of claim 10, the operations further comprising:
detecting that hardware acceleration has been disabled for rendering the display;
wherein rendering the display without hardware acceleration is based on detecting that the hardware acceleration has been disabled.

12. The system of claim 10, the operations further comprising:
generating a hardware renderer, the hardware renderer performing the step of rendering the display using hardware acceleration;
wherein disabling hardware acceleration comprises destroying the hardware renderer.

13. The system of claim 12, the operations further comprising:
detecting the absence of a hardware renderer for the display;
wherein rendering the display without hardware acceleration is based on detecting the absence of a hardware renderer for the display.

14. The system of claim 10, wherein the error is an impermissible state.

15. A non-transitory computer-readable medium storing software comprising instructions executable by one or more computers which, upon such execution, cause the one or more computers to perform operations comprising:
rendering a display of an application using hardware acceleration;
detecting an error in the hardware accelerated rendering of the display;
in response to detecting the error, disabling hardware acceleration for further rendering of the display; and
subsequent to disabling the hardware acceleration for further rendering of the display, rendering the display without hardware acceleration.

16. The medium of claim 15, the operations further comprising:
detecting that hardware acceleration has been disabled for rendering the display;
wherein rendering the display without hardware acceleration is based on detecting that the hardware acceleration has been disabled.

17. The medium of claim 15, the operations further comprising:
generating a hardware renderer, the hardware renderer performing the step of rendering the display using hardware acceleration;
wherein disabling hardware acceleration comprises destroying the hardware renderer.

18. The method of claim 17, further comprising:
detecting the absence of a hardware renderer for the display;
wherein rendering the display without hardware acceleration is based on detecting the absence of a hardware renderer for the display.

19. The medium of claim 15, wherein the error is an impermissible state.
